(19) United States
(12) Patent Application Publication
(10) Pub. No.: US 2013/0288001 A1
(43) Pub. Date: Oct. 31, 2013

(54) TEMPERED GLASS, AND TEMPERED GLASS PLATE

(71) Applicants: Takashi Murata, Shiga (JP); Takako Tojyo, Shiga (JP)

(72) Inventors: Takashi Murata, Shiga (JP); Takako Tojyo, Shiga (JP)

(21) Appl. No.: 13/979,276

(22) PCT Filed: Jan. 16, 2012
(86) PCT No.: PCT/JP2012/050707

§ 371 Date: Jul. 11, 2013

(30) Foreign Application Priority Data
Jan. 18, 2011 (JP) 2011-007415

(51) Int. Cl. C03C 3/097; C03C 3/091; C03C 3/087; C03C 15/00; C03C 3/085

(52) U.S. Cl. CPC C03C 3/097; C03C 15/00; C03C 3/085; C03C 3/087; C03C 3/091
USPC 428/141; 428/410; 428/156; 428/192; 501/63; 501/69; 501/70; 501/66

(57) ABSTRACT

Provided is a tempered glass having a compression stress layer in a surface thereof, the tempered glass comprising, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein the surface is etched partially or entirely before tempering treatment.

### TECHNICAL FIELD

The present invention relates to a tempered glass and a tempered glass sheet, and more particularly, to a tempered glass and a tempered glass sheet suitable for a cover glass for a cellular phone, a digital camera, a personal digital assistant (PDA), or a solar cell, or a glass substrate for a display, in particular, a touch panel display.

### BACKGROUND ART

In recent years, a PDA provided with a touch panel has been marketed, and a tempered glass is used for protecting a display part of the PAD (see, for example, Patent Literature 1 and Non Patent Literature 1). In future, the market of a tempered glass is expected to develop increasingly. Besides, the tempered glass for this application is required to have a high mechanical strength and it is often important for the tempered glass to have designability.

Further, the tempered glass for this application is, for example, produced as follows. Glass is first cut into a glass piece so as to have a shape matching that of a display part of each device. Then, a drilling process is applied to microphone and speaker parts of the glass piece, and a surface of the glass piece is polished to reduce a thickness thereof and to remove chipping of the peripheral part of the glass piece and chipping of the drilled part thereof. Finally, the whole glass piece is immersed in an ion exchange furnace, thus producing the tempered glass.

### CITATION LIST

### Patent Literature

Patent Literature 1: JP 2006-83045 A

### Non Patent Literature

Non Patent Literature 1: Tetsuro Izumitani et al., “New glass and physical properties thereof,” First edition, Management System Laboratory. Co., Ltd., Aug. 20, 1984, p. 451-498

### SUMMARY OF INVENTION

### Technical Problem

A tempered glass used for protecting a display part is required to have a high mechanical strength. However, when a peripheral process, a drilling process, and general polishing treatment are applied to glass, the tempered glass may have a reduced mechanical strength. In order to prevent such situation, it is necessary to remove fine cracks existing in the edge surfaces of the glass. Specifically, it is necessary to apply mirror finishing to the edge surfaces of the glass and a polishing process such as mirror polishing to the surfaces thereof after performing a peripheral process and a drilling process. As a result, the production cost of the tempered glass significantly increases.

In view of the above-mentioned circumstances, studies have been made on how to remove cracks existing in the edge surfaces of glass by a method other than the mirror polishing. For example, studies have been made on a method involving etching the surfaces of glass, thereby reducing the depth of the cracks existing in the edge surfaces thereof and thus increasing the mechanical strength of the glass (tempered glass). However, when etching is applied to the surfaces of glass under a severe condition in order to improve the productivity of the tempered glass, the surfaces of the glass are roughened and it is difficult for the tempered glass to have surface quality (a surface roughness Ra of 1 nm or less) necessary for a display part of a cellular phone. On the other hand, when etching is performed at a too low rate of etching, the productivity of the tempered glass deteriorates.

Thus, a technical object of the present invention is to invent a tempered glass which can have surface quality necessary for a display part of a cellular phone, can be produced at a higher rate of etching, and has a higher mechanical strength.

### Solution to Problem

The inventors of the present invention have made various studies and have consequently found that the technical object can be achieved by strictly controlling the content range of each component in a glass composition and etching the surface of glass before tempering treatment. Thus, the finding is proposed as the present invention. That is, a tempered glass of the present invention is a tempered glass having a compression stress layer in a surface thereof, the tempered glass comprising, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein the surface is etched partially or entirely before tempering treatment. Herein, the “MgO+CaO” refers to the total amount of MgO and CaO. The “Al₂O₃+Na₂O+P₂O₅” refers to the total amount of Al₂O₃, Na₂O, and P₂O₅. The “B₂O₃+Na₂O” refers to the total amount of B₂O₃ and Na₂O.

Second, it is preferred that the tempered glass of the present invention comprise, as a glass composition in terms of mol %, 45 to 75% of SiO₂, 4 to 13% of Al₂O₃, 0 to 3% of B₂O₃, 0 to 8% of Li₂O, 5 to 20% of Na₂O, 0.1 to 10% of K₂O, and 3 to 13% of MgO+CaO, and have a molar ratio (Al₂O₃+Na₂O+P₂O₅)/SiO₂ of 0.1 to 0.7, a molar ratio (B₂O₃+Na₂O)/SiO₂ of 0.1 to 0.7, a molar ratio P₂O₅/SiO₂ of 0 to 0.5, a molar ratio Al₂O₃/SiO₂ of 0.01 to 0.7, and a molar ratio Na₂O/Al₂O₃ of 0.5 to 4.

Third, it is preferred that the tempered glass of the present invention comprise, as a glass composition in terms of mol %, 45 to 75% of SiO₂, 5 to 12% of Al₂O₃, 0 to 1% of B₂O₃, 0 to 4% of Li₂O, 8 to 20% of Na₂O, 0.5 to 10% of K₂O, and 5 to 13% of MgO+CaO, and have a molar ratio (Al₂O₂+Na₂O+P₂O₅)/SiO₂ of 0.1 to 0.5, a molar ratio (B₂O₂+Na₂O)/SiO₂ of 0.1 to 0.5, a molar ratio P₂O₅/SiO₂ of 0 to 0.3, a molar ratio Al₂O₂/SiO₂ of 0.05 to 0.5, and a molar ratio Na₂O/Al₂O₂ of 1 to 3.

Fourth, it is preferred that the tempered glass of the present invention comprise, as a glass composition in terms of mol %, 45 to 75% of SiO₂, 5 to 11% of Al₂O₂, 0 to 1% of B₂O₃, 0 to 4% of Li₂O, 9 to 20% of Na₂O, 0.5 to 8% of K₂O, 0 to 12% of MgO, 0 to 3% of CaO, and 5 to 12% of MgO+CaO, and have a molar ratio (Al₂O₂+Na₂O+P₂O₅)/SiO₂ of 0.1 to 0.5, a molar ratio (B₂O₂+Na₂O)/SiO₂ of 0.1 to 0.3, a molar ratio P₂O₅/SiO₂ of 0 to 0.2, a molar ratio Al₂O₂/SiO₂ of 0.05 to 0.3, and a molar ratio Na₂O/Al₂O₂ of 1 to 3.

Fifth, it is preferred that the tempered glass of the present invention comprise, as a glass composition in terms of mol %, 50 to 70% of SiO₂, 5 to 11% of Al₂O₂, 0 to 1% of B₂O₃, 0 to 2% of Li₂O, 10 to 18% of Na₂₀, 1 to 6% of K₂O, 0 to 12% of MgO, 0 to 2.5% of CaO, and 5 to 12% of MgO+CaO, and have a molar ratio (Al₂O₂+Na₂O+P₂O₅)/SiO₂ of 0.2 to 0.5, a molar ratio (B₂O₂+Na₂O)/SiO₂ of 0.15 to 0.27, a molar ratio P₂O₅/SiO₂ of 0 to 0.1, a molar ratio Al₂O₂/SiO₂ of 0.07 to 0.2, and a molar ratio Na₂O/Al₂O₂ of 1 to 2.3.

Sixth, in the tempered glass of the present invention, it is preferred that the surface be etched partially or entirely with an etching liquid comprising at least one kind selected from the group consisting of HF, HCl, H₂SO₄, HNO₃, NH₄F, NaOH, and NH₄HF₂. Note that those components have good performance for etching.

Seventh, in the tempered glass of the present invention, it is preferred that a surface roughness Ra of the etched surface be 1 nm or less. Herein, the “surface roughness Ra” refers to a value obtained by a measurement method in accordance with SEMI D7-94 “FPD glass substrate surface roughness measurement method.” Further, the “surface roughness Ra of the etched surface” refers to the surface roughness Ra of an etched surface excluding an edge surface.

Eighth, it is preferred that the tempered glass of the present invention have a value of (surface roughness Ra of edge surface)/(surface roughness Ra of etched surface) of 1 to 5,000.

Ninth, in the tempered glass of the present invention, it is preferred that a compression stress value of the compression stress layer be 200 MPa or more, and a thickness (depth) of the compression stress layer be 10 μm or more. Herein, the “compression stress value of the compression stress layer” and the “thickness of the compression stress layer” refer to values which are calculated from the number of interference fringes on a sample and each interval between the interference fringes, the interference fringes being observed when a surface stress meter (such as FSM-6000 manufactured by Toshiba Corporation) is used to observe the sample.

Tenth, it is preferred that the tempered glass of the present invention have a liquidus temperature of 1,250° C. or less. Herein, the “liquidus temperature” refers to a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

Eleventh, it is preferred that the tempered glass of the present invention have a liquidus viscosity of 10^{4.0} dPa·s or more. Herein, the “liquidus viscosity” refers to a value obtained through measurement of a viscosity of glass at the liquidus temperature by a platinum sphere pull up method.

Twelfth, it is preferred that the tempered glass of the present invention have a temperature at 10^{4.0} dPa·s of 1,280° C. or less. Herein, the “temperature at 10^{4.0} dPa·s” refers to a value obtained through measurement by a platinum sphere pull up method.

Thirteenth, it is preferred that the tempered glass of the present invention have a temperature at 10^{2.5} dPa·s of 1,620° C. or less. Herein, the “temperature at 10^{2.5} dPa·s” refers to a value obtained through measurement by a platinum sphere pull up method.

Fourteenth, it is preferred that the tempered glass of the present invention have a density of 2.6 g/cm³ or less. Herein, the “density” may be measured by a well-known Archimedes method.

Fifteenth, a tempered glass sheet of the present invention comprises any one of the tempered glasses.

Sixteenth, it is preferred that the tempered glass sheet of the present invention be formed by a float method.

Seventeenth, it is preferred that the tempered glass sheet of the present invention be used for a touch panel display.

Eighteenth, it is preferred that the tempered glass sheet of the present invention be used for a cover glass for a cellular phone.

Nineteenth, it is preferred that the tempered glass sheet of the present invention be used for a cover glass for a solar cell.

Twentieth, it is preferred that the tempered glass sheet of the present invention be used for a protective member for a display.

Twenty-first, a glass to be tempered of the present invention comprises, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and has a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein a surface of the glass to be tempered is etched partially or entirely.

Twenty-second, it is preferred that the glass to be tempered of the present invention have a mass reduction of 0.05 to 50 g/cm² when immersed in a 10-mass % HCl aqueous solution at 80° C. for 24 hours.

### Advantageous Effects of Invention

The tempered glass of the present invention has proper performance for etching. Hence, etching for a short time can reduce the thickness of the glass to be tempered and can remove cracks existing in the edge surfaces of the glass, thereby being able to provide high surface quality to the tempered glass. In addition, the tempered glass of the present invention has high ion exchange performance. Hence, the tempered glass has a high mechanical strength and a variation in the mechanical strength is small.

### BRIEF DESCRIPTION OF DRAWINGS

FIG. 1 An observation image and roughness profile of a surface of a lapped glass sheet after being immersed in a 5-mass % HF aqueous solution at 25° C. for 10 minutes in Example 2.

FIG. 2 An observation image and roughness profile of an edge surface of the lapped glass sheet after being immersed in the 5-mass % HF aqueous solution at 25° C. for 10 minutes in Example 2.

### DESCRIPTION OF EMBODIMENTS

A tempered glass according to an embodiment of the present invention is a tempered glass having a compression stress layer in a surface thereof, the tempered glass comprising, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein the surface is etched partially or entirely before tempering treatment. Note that the expression “%” refers to “mol %” in the following description of the content range of each component.

A method of forming the compression stress layer in the surface includes a physical tempering method and a chemical tempering method. The tempered glass of the present invention is preferably produced by a chemical tempering method.

The chemical tempering method is a method involving introducing alkali ions each having a large ion radius into the surface of glass by ion exchange treatment at a temperature equal to or lower than a strain point of the glass. When the chemical tempering method is used to form a compression stress layer, the compression stress layer can be properly formed even in the case where the thickness of the glass is small. In addition, even when a tempered glass is cut after the formation of the compression stress layer, the tempered glass does not easily break unlike a tempered glass produced by applying a physical tempering method such as an air cooling tempering method.

The tempered glass according to this embodiment is formed by etching at least a part of the surfaces of glass before tempering treatment. As a result, each depth of the cracks existing in the edge surfaces of the glass can be reduced and the mechanical strength of the glass can be enhanced. In this case, the etching is preferably applied entirely to any one of the front surface and back surface of the glass, and more preferably applied entirely to both the front surface and back surface.

The reasons why the content range of each component in the tempered glass according to this embodiment is controlled in the above-mentioned range are described below.

SiO₂ is a component that forms a network of glass. The content of SiO₂ is 45 to 75%, preferably 50 to 70%, 55 to 68%, 55 to 67%, particularly preferably 58 to 66%. When the content of SiO₂ is too small, vitrification does not occur easily, the thermal expansion coefficient becomes too high, the thermal shock resistance is liable to lower, and the rate of etching with an acid such as HCl becomes too high, with the result that it is difficult to obtain desired surface quality. On the other hand, when the content of SiO₂ is too large, the meltability and formability are liable to lower, the thermal expansion coefficient becomes too low, with the result that it is difficult to match the thermal expansion coefficient with those of peripheral materials. In addition, the rate of etching becomes low and hence it is difficult to reduce the thickness to a desired one, with the result that the productivity of the tempered glass is liable to lower.

Al₂O₃ is a component that enhances the ion exchange performance and is a component that enhances the strain point or Young's modulus. The content of Al₂O₃ is 3 to 15%. When the content of Al₂O₃ is too small, the ion exchange performance may not be exerted sufficiently. Thus, the lower limit range of Al₂O₃ is suitably 4% or more, 5% or more, 5.5% or more, 7% or more, 8% or more, particularly suitably 9% or more. On the other hand, when the content of Al₂O₃ is too large, devitrified crystals are liable to be deposited in the glass, and it is difficult to form a glass sheet by a float method, an overflow down-draw method, or the like. Further, the thermal expansion coefficient becomes too low, and it is difficult to match the thermal expansion coefficient with those of peripheral materials. In addition, the viscosity at high temperature increases and the meltability is liable to lower. In addition, the rate of etching with an acid such as HCl becomes too high, and hence the glass is difficult to have desired surface quality. Thus, the upper limit range of Al₂O₃ is suitably 13% or less, 12% or less, 11% or less, particularly suitably 9% or less.

B₂O₃ is a component that lowers the viscosity at high temperature and density, stabilizes glass for a crystal to be unlikely precipitated, and lowers the liquidus temperature. However, when the content of B₂O₃ is too large, through ion exchange, coloring on the surface of glass called weathering may occur, water resistance may lower, the compression stress value of the compression stress layer may lower, the depth of the compression stress layer may decrease, and the rate of etching with an acid such as HCl becomes too high, with the result that it is difficult to obtain desired surface quality. Thus, the content of B₂O₃ is 0 to 12%, preferably 0 to 5%, 0 to 3%, 0 to 1.5%, 0 to 1%, 0 to 0.9%, 0 to 0.5%, particularly preferably 0 to 0.1%.

Li₂O is an ion exchange component, is a component that lowers the viscosity at high temperature to increase the meltability and formability, and is a component that increases the Young's modulus. Further, Li₂O has a great effect of increasing the compression stress value among alkali metal oxides, but when the content of Li₂O becomes extremely large in a glass system containing Na₂O at 5% or more, the compression stress value tends to lower to the worse. Further, when the content of Li₂O is too large, the liquidus viscosity lowers, the glass is liable to denitrify, and the thermal expansion coefficient becomes too high, with the result that the thermal shock resistance lowers and it is difficult to match the thermal expansion coefficient with those of peripheral materials. In addition, the viscosity at low temperature becomes too low, and the stress relaxation is liable to occur, with the result that the compression stress value lowers to the worse in some cases. Thus, the content of Li₂O is 0 to 12%, preferably 0 to 8%, 0 to 4%, 0 to 2%, 0 to 1%, 0 to 0.5%, 0 to 0.3%, particularly preferably 0 to 0.1%.

Na₂O is an ion exchange component and is a component that lowers the viscosity at high temperature to increase the meltability and formability. Na₂O is also a component that improves the denitrification resistance. The content of Na₂O is 0.3 to 20%. When the content of Na₂O is too small, the meltability lowers, the thermal expansion coefficient lowers, and the ion exchange performance is liable to lower. In addition, the rate of etching is low, and hence it is difficult to reduce the thickness to a desired one, with the result that the productivity of the tempered glass is liable to deteriorate. Thus, when Na₂O is added, the lower limit range of Na₂O is suitably 5% or more, 8% or more, 9% or more, 10% or more, 11% or more, particularly suitably 12% or more. On the other hand, when the content of Na₂O is too large, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the devitrification resistance lowers to the worse in some cases. In addition, the rate of etching with an acid such as HCl is too high, and hence the glass is difficult to have desired surface quality. Thus, the upper limit range of Na₂O is suitably 19% or less, 18% or less, 17% or less, particularly suitably 16% or less.

K₂O is a component that promotes ion exchange and allows the thickness of the compression stress layer to be easily increased among alkali metal oxides. K₂O is also a component that lowers the viscosity at high temperature to increase the meltability and formability. K₂O is also a component that improves devitrification resistance. The content of K₂O is 0 to 10%. When the content of K₂O is too large, the thermal expansion coefficient becomes too large, the thermal shock resistance lowers, and it is difficult to match the thermal expansion coefficient with those of peripheral materials. Further, the strain point lowers excessively, and the glass composition loses its component balance, with the result that the devitrification resistance tends to lower to the worse. Thus, the upper limit range of K₂O is suitably 8% or less, 7% or less, 6% or less, particularly suitably 5% or less. Note that, when K₂O is added to the glass composition, the lower limit range of K₂O is suitably 0.1% or more, 0.5% or more, 1% or more, 1.5% or more, 2% or more, particularly suitably 2.5% or more.

MgO is a component that reduces the viscosity at high temperature to enhance the meltability and formability, and increases the strain point and Young's modulus, and is a component that has a great effect of enhancing the ion exchange performance among alkaline earth metal oxides. However, when the content of MgO is too large, the density and thermal expansion coefficient increase, and the glass is liable to devitrify. Thus, the upper limit range of MgO is suitably 12% or less, 10% or less, 8% or less, particularly suitably 7% or less. When MgO is added to the glass composition, the lower limit range of MgO is suitably 0.1% or more, 0.5% or more, 1% or more, 2% or more, particularly suitably 3% or more.

CaO has great effects of reducing the viscosity at high temperature to enhance the meltability and formability and increasing the strain point and Young's modulus without causing any reduction in denitrification resistance as compared to other components. The content of CaO is preferably 0 to 10%. However, when the content of CaO is too large, the density and thermal expansion coefficient increase, and the glass composition loses its component balance, with the results that the glass is liable to devitrify to the worse, and the ion exchange performance is liable to lower. In addition, phase separation is liable to occur. Thus, the content of CaO is suitably 0 to 5%, 0 to 3%, particularly suitably 0 to 2.5%.

P₂O₅ is a component that enhances the ion exchange performance and a component that increases the thickness of the compression stress layer, in particular. However, when the content of P₂O₅ is too large, phase separation occurs in the glass, the rate of etching with an acid such as HCl is too high, and hence the glass is difficult to have desired surface quality. Thus, the upper limit range of P₂O₅ is suitably 10% or less, 5% or less, particularly suitably 3% or less. Note that, when P₂O₅ is added to the glass composition, the lower limit range of P₂O₅ is suitably 0.01% or more, 0.1% or more, 0.5% or more, particularly suitably 1% or more.

The content of MgO+CaO is 1 to 15%. When the content of MgO+CaO is too small, the glass is difficult to have desired ion exchange performance, the viscosity at high temperature increases, and the meltability•Solubility

is liable to deteriorate. On the other hand, when the content of MgO+CaO is too large, the density and thermal expansion coefficient increase and the denitrification resistance is liable to deteriorate. Thus, the content range of MgO+CaO is suitably 3 to 13%, 5 to 13%, 5 to 12%, particularly suitably 5 to 11%.

The content of Li₂O+Na₂O+K₂O is suitably 5 to 25%, 8 to 22%, 12 to 20%, particularly suitably 16.5 to 20%. When the content of Li₂O+Na₂O+K₂O is too small, the ion exchange performance and meltability are liable to deteriorate. On the other hand, when the content of Li₂O+Na₂O+K₂O is too large, the glass is liable to denitrify and the thermal expansion coefficient increases excessively, with the result that the thermal shock resistance deteriorates and it is difficult to match the thermal expansion coefficient with those of peripheral materials. In addition, the strain point lowers excessively, with the result that a high compression stress value is hardly achieved in some cases. Moreover, the viscosity at around its liquidus temperature lowers, with the result that the glass is difficult to have a high liquidus viscosity in some cases. Note that the “Li₂O+Na₂O+K₂O” refers to the total amount of Li₂O, Na₂O, and K₂O.

The tempered glass according to this embodiment has a molar ratio (Al₂O₃+Na₂O+P₂O₅)/SiO₂ of 0.1 to 1. When the molar ratio (Al₂O₃+Na₂O+P₂O₅)/SiO₂ is too small, the rate of etching is low, and hence it is difficult to reduce the thickness to a desired one, with the result that the productivity of the tempered glass is liable to deteriorate. In addition, the ion exchange performance is liable to deteriorate. On the other hand, when the molar ratio (Al₂O₃+Na₂O+P₂O₅)/SiO₂ is too large, the rate of etching with an acid such as HCl is too high, and hence the glass is difficult to have desired surface quality, the denitrification resistance deteriorates, and the glass is difficult to have a high liquidus viscosity. Thus, the lower limit range of the molar ratio (Al₂O₃+Na₂O+P₂O₅)/SiO₂ is suitably 0.15 or more, 0.2 or more, particularly suitably 0.25 or more, and the upper limit range thereof is suitably 0.7 or less, 0.5 or less, particularly suitably 0.4 or less.

The tempered glass according to this embodiment has a molar ratio (B₂O₃+Na₂O)/SiO₂ of 0.1 to 1. When the molar ratio (B₂O₃+Na₂O)/SiO₂ is too small, the rate of etching is low, and hence it is difficult to reduce the thickness to a desired one, with the result that the productivity of the tempered glass is liable to deteriorate. In addition, the viscosity at high temperature increases, and hence the meltability deteriorates, with the result that the bubble quality is liable to deteriorate. On the other hand, when the molar ratio (B₂O₃+Na₂O)/SiO₂ is too large, the rate of etching with an acid such as HCl is too high, and hence the glass is difficult to have desired surface quality, the denitrification resistance deteriorates, and the glass is difficult to have a high liquidus viscosity. Thus, the lower limit range of the molar ratio (B₂O₃+Na₂O)/SiO₂ is suitably 0.15 or more, 0.2 or more, particularly suitably 0.23 or more, and the upper limit range thereof is suitably 0.7 or less, 0.5 or less, 0.4 or less, 0.3 or less, particularly suitably 0.27 or less.

The tempered glass according to this embodiment has a molar ratio P₂O₅/SiO₂ of 0 to 1. When the molar ratio P₂O₅/SiO₂ is large, the compression stress layer tends to have a large thickness. However, when the value of the molar ratio is too large, the rate of etching with an acid such as HCl is too high, and hence the glass is difficult to have desired surface quality. Thus, the range of the molar ratio P₂O₅/SiO₂ is suitably 0 to 0.5, 0 to 0.3, 0 to 0.2, particularly suitably 0 to 0.1.

The tempered glass according to this embodiment has a molar ratio Al₂O₃/SiO₂ of 0.01 to 1. When the molar ratio Al₂O₃/SiO₂ is larger, the strain point and Young's modulus increase and the ion exchange performance can be enhanced. However, when the value of the molar ratio is too large, devitrified crystals are liable to be deposited in the glass, the glass is difficult to have a high liquidus viscosity, the viscosity at high temperature increases, the meltability is liable to deteriorate, the rate of etching with an acid such as HCl is too high, and hence the glass is difficult to have desired surface quality. Thus, the range of the molar ratio Al₂O₃/SiO₂ is suitably 0.01 to 0.7, 0.01 to 0.5, 0.05 to 0.3, particularly suitably 0.07 to 0.2.

The tempered glass according to this embodiment has a molar ratio Na₂O/Al₂O₃ of 0.1 to 5. When the molar ratio Na₂O/Al₂O₃ is too small, the denitrification resistance is liable to deteriorate and the meltability is liable to deteriorate. On the other hand, when the molar ratio Na₂O/Al₂O₃ is too large, the thermal expansion coefficient becomes too high, the viscosity at high temperature becomes too low, and hence the glass is difficult to have a high liquidus viscosity. Thus, the range of the molar ratio Na₂O/Al₂O₃ is suitably 0.5 to 4, 1 to 3, particularly suitably 1.2 to 2.3.

In addition to the components described above, for example, the following components may be added.

SrO is a component that reduces the viscosity at high temperature to increase the meltability and formability and increases the strain point and Young's modulus without causing any reduction in devitrification resistance. When the content of SrO is too large, the density and thermal expansion coefficient increase, the ion exchange performance lowers, and the glass composition loses its component balance, with the result that the glass is liable to devitrify to the worse. The content range of SrO is suitably 0 to 5%, 0 to 3%, 0 to 1%, particularly suitably 0 to 0.1%.

BaO is a component that reduces the viscosity at high temperature to increase the meltability and formability and increases the strain point and Young's modulus without causing any reduction in devitrification resistance. When the content of BaO is too large, the density and thermal expansion coefficient increase, the ion exchange performance lowers, and the glass composition loses its component balance, with the result that the glass is liable to devitrify to the worse. The content range of BaO is suitably 0 to 5%, 0 to 3%, 0 to 1%, particularly suitably 0 to 0.1%.

TiO₂ is a component that enhances the ion exchange performance and is a component that reduces the viscosity at high temperature. When the content of TiO₂ is too large, the glass is liable to be colored and to devitrify. Thus, the content of TiO₂ is preferably 0 to 3%, 0 to 1%, 0 to 0.8%, 0 to 0.5%, particularly preferably 0 to 0.1%.

ZrO₂ is a component that remarkably enhances the ion exchange performance and is a component that increases the viscosity around the liquidus viscosity and the strain point. However, when the content of ZrO₂ is too large, the devitrification resistance may lower remarkably and the density may increase excessively. Thus, the upper limit range of ZrO₂ is suitably 10% or less, 8% or less, 6% or less, 4% or less, particularly suitably 3% or less. Note that, when the enhancement of the ion exchange performance is intended, ZrO₂ is preferably added to the glass composition, and the lower limit range of ZrO₂ is suitably 0.01% or more, 0.1% or more, 0.5% or more, 1% or more, particularly suitably 2% or more.

ZnO is a component that enhances the ion exchange performance and is a component that has a great effect of increasing the compression stress value, in particular. Further, ZnO is a component that reduces the viscosity at high temperature without reducing the viscosity at low temperature. However, when the content of ZnO is too large, the glass manifests phase separation, the devitrification resistance lowers, the density increases, and the thickness of the compression stress layer in the glass tends to decrease. Thus, the content of ZnO is preferably 0 to 6%, 0 to 5%, 0 to 3%, 0 to 1%, particularly preferably 0 to 0.5%.

As a fining agent, one kind or two or more kinds selected from the group consisting of As₂O₃, Sb₂O₃, CeO₂, SnO₂, F, Cl, and SO₃ (preferably the group consisting of SnO₂, Cl, and SO₃) may be added at 0 to 3%. The content of SnO₂+SO₃+Cl is preferably 0 to 1%, 100 to 3,000 ppm, 300 to 2,500 ppm, particularly preferably 500 to 2,500 ppm. Note that, when the content of SnO₂+SO₃+Cl is less than 100 ppm, it is difficult to obtain a fining effect. Herein, the “SnO₂+SO₃+Cl” refers to the total amount of SnO₂, SO₃, and Cl.

The tempered glass preferably contains As₂O₃, Sb₂O₃, and F as little as possible, and is more preferably substantially free of As₂O₃, Sb₂O₃, and F from the standpoint of environmental considerations. Herein, the gist of the phrase “substantially free of As₂O₃” resides in that As₂O₃ is not added positively as a glass component, but contamination with As₂O₃ as an impurity is allowable. Specifically, the phrase means that the content of As₂O₃ is less than 500 ppm (by mass). The gist of the phrase “substantially free of Sb₂O₃” resides in that Sb₂O₃ is not added positively as a glass component, but contamination with Sb₂O₃ as an impurity is allowable. Specifically, the phrase means that the content of Sb₂O₃ is less than 500 ppm (by mass). The gist of the phrase “substantially free of F” resides in that F is not added positively as a glass component, but contamination with F as an impurity is allowable. Specifically, the phrase means that the content of F is less than 500 ppm (by mass).

The content of Fe₂O₃ is preferably less than 500 ppm, less than 400 ppm, less than 300 ppm, less than 200 ppm, particularly preferably less than 150 ppm. With this, the transmittance (400 nm to 770 nm) of glass having a thickness of 1 mm is easily improved (for example, 90% or more).

A rare earth oxide such as Nb₂O₅ or La₂O₃ is a component that increases the Young's modulus. However, the cost of the raw material itself is high, and when the rare earth oxide is added in a large amount, the denitrification resistance is liable to lower. Thus, the content of the rare earth oxide is preferably 3% or less, 2% or less, 1% or less, 0.5% or less, particularly preferably 0.1% or less.

A transition metal element (such as Co or Ni) that causes the intense coloration of glass may reduce the transmittance of glass. In particular, in the case where the glass is used for a touch panel display, when the content of the transition metal element is too large, the visibility of the touch panel display is liable to lower. Thus, it is preferred to select a glass raw material (including cullet) so that the content of a transition metal oxide is 0.5% or less, 0.1% or less, particularly 0.05% or less.

The tempered glass is preferably substantially free of PbO and Bi₂O₃ from environmental considerations. Herein, the gist of the phrase “substantially free of PbO” resides in that PbO is not added positively as a glass component, but contamination with PbO as an impurity is allowable. Specifically, the phrase means that the content of PbO is less than 500 ppm (by mass). The gist of the phrase “substantially free of Bi₂O₃” resides in that Bi₂O₃ is not added positively as a glass component, but contamination with Bi₂O₃ as an impurity is allowable. Specifically, the phrase means that the content of Bi₂O₃ is less than 500 ppm (by mass).

In the tempered glass according to this embodiment, it is possible to construct suitable glass composition ranges by appropriately selecting suitable content ranges of the respective components. Of those, as a particularly suitable glass composition range, the tempered glass comprises, in terms of mol %, 50 to 70% of SiO₂, 5.5 to 9% of Al₂O₃, 0 to 0.1% of B₂O₃, 0 to 0.5% of Li₂O, 12 to 17% of Na₂O, 2 to 5% of K₂O, 0 to 12% of MgO, 0 to 2.5% of CaO, and 5 to 11% of MgO+CaO, and has a molar ratio (Al₂O₃+Na₂O+P₂O₅)/SiO₂ of 0.25 to 0.5, a molar ratio (B₂O₃+Na₂O)/SiO₂ of 0.15 to 0.27, a molar ratio P₂O₅/SiO₂ of 0 to 0.1, a molar ratio Al₂O₃/SiO₂ of 0.07 to 0.2, and a molar ratio Na₂O/Al₂O₃ of 1.2 to 2.3.

The tempered glass according to this embodiment has a compression stress layer in a surface thereof. The compression stress value of the compression stress layer is preferably 300 MPa or more, 400 MPa or more, 500 MPa or more, 600 MPa or more, 700 MPa or more, particularly preferably 800 MPa or more. As the compression stress value becomes larger, the mechanical strength of the tempered glass becomes higher. On the other hand, when an extremely large compression stress is formed on the surface of the tempered glass, micro cracks are generated on the surface, which may reduce the mechanical strength of the tempered glass to the worse. Further, a tensile stress inherent in the tempered glass may extremely increase. Thus, the compression stress value of the compression stress layer is preferably 1,500 MPa or less. Note that there is a tendency that the compression stress value is increased by increasing the content of Al₂O₃, TiO₂, ZrO₂, MgO, or ZnO in the glass composition or by decreasing the content of SrO or BaO in the glass composition. Further, there is a tendency that the compression stress value is increased by shortening a time necessary for ion exchange or by decreasing the temperature of an ion exchange solution.

The thickness of the compression stress layer is preferably 10 μm or more, 25 μm or more, 50 μm or more, 60 μm or more, particularly preferably 70 μm or more. As the thickness of the compression stress layer becomes larger, the tempered glass is more hardly cracked even when the tempered glass has a deep flaw, and a variation in the mechanical strength of the tempered glass becomes smaller. On the other hand, as the thickness of the compression stress layer becomes larger, it becomes more difficult to cut the tempered glass. Thus, the thickness of the compression stress layer is preferably 500 μm or less, 200 μm or less, 150 μm or less, particularly preferably 90 μm or less. Note that there is a tendency that the thickness of the compression stress layer is increased by increasing the content of K₂O or P₂O₅ in the glass composition or by decreasing the content of SrO or BaO in the glass composition. Further, there is a tendency that the thickness of the compression stress layer is increased by lengthening a time necessary for ion exchange or by increasing the temperature of an ion exchange solution.

The tempered glass according to this embodiment has a density of preferably 2.6 g/cm³ or less, particularly preferably 2.55 g/cm³ or less. As the density becomes smaller, the weight of the tempered glass can be reduced more. Note that the density is easily reduced by increasing the content of SiO₂, B₂O₃, or P₂O₅ in the glass composition or by decreasing the content of an alkali metal oxide, an alkaline earth metal oxide, ZnO, ZrO₂, or TiO₂ in the glass composition.

The tempered glass according to this embodiment has a thermal expansion coefficient in the temperature range of 30 to 380° C. of preferably 80 to 120×10⁻⁷/° C., 85 to 110×10⁻⁷/° C., 90 to 110×10⁻⁷/° C., particularly preferably 90 to 105×10⁻⁷/° C. When the thermal expansion coefficient is controlled within the above-mentioned ranges, it becomes easy to match the thermal expansion coefficient with those of members made of a metal, an organic adhesive, and the like, and the members made of a metal, an organic adhesive, and the like are easily prevented from being peeled off. Herein, the “thermal expansion coefficient in the temperature range of 30 to 380° C.” refers to a value obtained through measurement of an average thermal expansion coefficient with a dilatometer. Note that the thermal expansion coefficient is easily increased by increasing the content of an alkali metal oxide or an alkaline earthmetal oxide in the glass composition, and in contrast, the thermal expansion coefficient is easily decreased by reducing the content of the alkali metal oxide or the alkaline earth metal oxide.

The tempered glass according to this embodiment has a strain point of preferably 500° C. or more, 520° C. or more, particularly preferably 530° C. or more. As the strain point becomes higher, the heat resistance is improved more, and the disappearance of the compression stress layer more hardly occurs when the tempered glass is subjected to thermal treatment. Further, as the strain point becomes higher, stress relaxation more hardly occurs during ion exchange treatment, and thus the compression stress value can be maintained more easily. Note that the strain point is easily increased by increasing the content of an alkaline earth metal oxide, Al₂O₃, ZrO₂, or P₂O₅ in the glass composition or by reducing the content of an alkali metal oxide in the glass composition.

The tempered glass according to this embodiment has a temperature at 10^{4.0} dPa·s of preferably 1,280° C. or less, 1,230° C. or less, 1,200° C. or less, 1,180° C. or less, particularly preferably 1,160° C. or less. As the temperature at 10^{4.0} dPa·s becomes lower, a burden on forming equipment is reduced more, the forming facility has a longer life, and consequently, the production cost of the tempered glass is more likely to be reduced. The temperature at 10^{4.0} dPa·s is easily decreased by increasing the content of an alkali metal oxide, an alkaline earth metal oxide, ZnO, B₂O₃, or TiO₂ or by reducing the content of SiO₂ or Al₂O₃.

The tempered glass according to this embodiment has a temperature at 10^{2.5} dPa·s of preferably 1,620° C. or less, 1,550° C. or less, 1,530° C. or less, 1,500° C. or less, particularly preferably 1,450° C. or less. As the temperature at 10^{2.5} dPa·s becomes lower, melting at lower temperature can be carried out, and hence a burden on glass production equipment such as a melting furnace is reduced more, and the bubble quality is improved more easily. That is, as the temperature at 10^{2.5} dPa·s becomes lower, the production cost of the tempered glass is more likely to be reduced. Note that the temperature at 10^{2.5} dPa·s corresponds to a melting temperature. Further, the temperature at 10^{2.5} dPa·s is easily decreased by increasing the content of an alkali metal oxide, an alkaline earth metal oxide, ZnO, B₂O₃, or TiO₂ in the glass composition or by reducing the content of SiO₂ or Al₂O₃ in the glass composition.

The tempered glass according to this embodiment has a liquidus temperature of preferably 1,200° C. or less, 1,150° C. or less, 1,100° C. or less, 1,050° C. or less, 1,000° C. or less, 950° C. or less, 900° C. or less, particularly preferably 880° C. or less. Note that as the liquidus temperature becomes lower, the denitrification resistance and formability are improved more. Further, the liquidus temperature is easily decreased by increasing the content of Na₂O, K₂O, or B₂O₃ in the glass composition or by reducing the content of Al₂O₃, Li₂O, MgO, ZnO, TiO₂, or ZrO₂.

The tempered glass according to this embodiment has a liquidus viscosity of preferably 10^{4.0} dPa·s or more, 10^{4.4} dPa·s or more, 10^{4.8} dPa·s or more, 10^{5.0} dPa·s or more, 10^{5.4} dPa·s or more, 10^{5.6} dPa·s or more, 10^{6.0} dPa·s or more, 10^{6.2} dPa·s or more, particularly preferably 10^{6.3} dPa·s or more. Note that, as the liquidus viscosity becomes higher, the denitrification resistance and formability are improved more. Further, the liquidus viscosity is easily increased by increasing the content of Na₂O or K₂O in the glass composition or by reducing the content of Al₂O₃, Li₂O, MgO, ZnO, TiO₂, or ZrO₂ in the glass composition.

The tempered glass according to this embodiment has a surface roughness Ra of the surfaces (excluding the edge surfaces) of preferably 1 nm or less, 0.5 nm or less, 0.3 nm or less, particularly preferably 0.2 nm or less. When the surface roughness Ra of the surfaces is too large, not only the appearance quality of the tempered glass deteriorates but also the mechanical strength thereof may deteriorate.

The tempered glass according to this embodiment has a surface roughness Ra of the etched surfaces of preferably 1 nm or less, 0.5 nm or less, 0.3 nm or less, particularly preferably 0.2 nm or less. When the surface roughness Ra of the etched surfaces is too large, not only the appearance quality of the tempered glass deteriorates but also the mechanical strength thereof may deteriorate.

The tempered glass according to this embodiment has a value of (surface roughness Ra of edge surfaces)/(surface roughness Ra of etched surfaces) of preferably 1 to 5,000, 1 to 1,000, 1 to 500, 1 to 300, 1 to 100, 1 to 50, particularly preferably 1 to 10. When this value is too large, the strength of the edge surfaces tends to deteriorate.

A tempered glass sheet according to an embodiment of the present invention comprises the tempered glass according to this embodiment already described. Thus, the technical features and suitable ranges of the tempered glass sheet according to this embodiment are the same as those of the tempered glass according to this embodiment. Herein, the descriptions thereof are omitted for convenience sake.

The tempered glass sheet according to this embodiment has a thickness of preferably 3.0 mm or less, 2.0 mm or less, 1.5 mm or less, 1.3 mm or less, 1.1 mm or less, 1.0 mm or less, 0.8 mm or less, particularly preferably 0.7 mm or less. On the other hand, when the thickness is excessively small, a desired mechanical strength is hardly provided. Thus, the thickness is preferably 0.1 mm or more, 0.2 mm or more, 0.3 mm or more, particularly preferably 0.4 mm or more.

A glass to be tempered according to an embodiment of the present invention comprises, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and has a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein a surface of the glass to be tempered is etched partially or entirely. The technical features of the glass to be tempered according to this embodiment are the same as those of the tempered glass and tempered glass sheet according to this embodiment. Herein, the description thereof is omitted for convenience sake.

When the glass to be tempered according to this embodiment is subjected to ion exchange treatment in a KNO₃ molten salt at 430° C., it is preferred that the compression stress value of a compression stress layer in a surface thereof be 300 MPa or more and the thickness of a compression stress layer be 10 μm or more, it is more preferred that the compression stress of a surface thereof be 600 MPa or more and the thickness of a compression stress layer be 40 μm or more, and it is still more preferred that the compression stress of a surface thereof be 800 MPa or more and the thickness of a compression stress layer be 60 μm or more.

When ion exchange treatment is performed, the temperature of the KNO₃ molten salt is preferably 400 to 550° C., and the ion exchange time is preferably 2 to 10 hours, particularly preferably 4 to 8 hours. With this, the compression stress layer can be properly formed easily. Note that the glass to be tempered according to this embodiment has the above-mentioned glass composition, and hence the compression stress value and thickness of the compression stress layer can be increased without using a mixture of a KNO₃ molten salt and an NaNO₃ molten salt or the like.

When the glass to be tempered according to this embodiment is immersed in a 10-mass % HCl aqueous solution at 80° C. for 24 hours, the glass to be tempered preferably has amass reduction of 0.05 to 50 g/cm². When this value is less than 0.05 g/cm², the rate of etching is low, and hence it is difficult to reduce the thickness to a desired one, with the result that the productivity of the tempered glass is liable to deteriorate. On the other hand, when this value is more than 50 g/cm², the rate of etching with an acid such as HCl is too high, and hence the glass is difficult to have desired surface quality. Note that the lower limit range of the mass reduction is suitably 0.1 g/cm² or more, particularly suitably 0.2 g/cm² or more. Further, the upper limit range of the mass reduction is suitably 45 g/cm² or less, 20 g/cm² or less, 10 g/cm² or less, 5 g/cm² or less, 2 g/cm² or less, particularly suitably 1 g/cm² or less.

When the glass to be tempered according to this embodiment is treated in a 5-mass % HF aqueous solution at 25° C. for 10 minutes, the surface roughness Ra of the etched surfaces is preferably 1 nm or less, 0.5 nm or less, 0.3 nm or less, particularly preferably 0.2 nm or less. When the surface roughness Ra of the etched surfaces is too large, not only the appearance quality of the tempered glass deteriorates but also the mechanical strength thereof may deteriorate.

When the glass to be tempered according to this embodiment is immersed in a 5-mass % HF aqueous solution at 25° C. for 10 minutes, the glass has a value of (surface roughness Ra of edge surfaces)/(surface roughness Ra of etched surfaces) of preferably 1 to 5,000, 1 to 1,000, 1 to 500, 1 to 300, 1 to 100, 1 to 50, particularly preferably 1 to 10. When this value is too large, the strength of the edge surfaces tends to deteriorate.

The glass to be tempered, tempered glass, and tempered glass sheet according to this embodiment can be produced as follows.

First, glass raw materials blended so as to have the above-mentioned glass composition are loaded into a continuous melting furnace, melted under heating at 1,500 to 1,600° C., and fined. After that, the molten glass is cast into a forming apparatus to form a sheet-shaped glass or the like, followed by annealing, thus being able to produce a glass having a sheet shape or the like.

A float method is preferably adopted as a method of forming molten glass into a sheet-shaped glass. The float method is a method by which a large number of glass sheets can be produced at low cost and by which even a large glass sheet can be easily produced.

Any of various forming methods other than the float method may be adopted. It is possible to adopt a forming method such as an overflow down-draw method, a down-draw method (such as a slot down method or a re-draw method), a roll out method, or a press method.

Next, the surfaces of the formed glass sheet are etched partially or entirely before tempering treatment. As a result of the etching, the thickness can be reduced without performing polishing or the like. When the edge surfaces are etched at the same time, cracks existing in the edge surfaces can also be removed. It is preferred to use an etching liquid comprising one kind or two or more kinds selected from the group consisting of HF, HCl, H₂SO₄, HNO₃, NH₄F, NaOH, and NH₄HF₂, in particular, one kind or two or more kinds selected from the group consisting of HCl, HF, and HNO₃. An etching aqueous solution having a concentration of preferably 1 to 20 mass %, 2 to 10 mass %, particularly preferably 3 to 8 mass % is used as the etching liquid. The temperature of the etching liquid used is preferably 20 to 50° C., 20 to 40° C., 20 to 30° C., except for the case of using HF. The time of the etching is preferably 1 to 20 minutes, 2 to 15 minutes, particularly preferably 3 to 10 minutes.

Next, the resultant glass can be subjected to tempering treatment to produce a tempered glass. The resultant glass may be cut into pieces having a predetermined size before the tempering treatment, but the cutting after the tempering treatment is advantageous in terms of cost.

Ion exchange treatment is preferably used as the tempering treatment. Conditions for the ion exchange treatment are not particularly limited, and optimum conditions may be selected in view of, for example, the viscosity properties, applications, thickness, and inner tensile stress of glass. The ion exchange treatment can be performed, for example, by immersing glass in a KNO₃ molten salt at 400 to 550° C. for 1 to 8 hours. Particularly when the ion exchange of K ions in the KNO₃ molten salt with Na components in the glass is performed, it is possible to form efficiently a compression stress layer in a surface of the glass.

### EXAMPLES

### Example 1

Hereinafter, examples of the present invention are described. Note that the following examples are merely illustrative. The present invention is by no means limited to the following examples.

Tables 1 to 3 show Examples of the present invention (sample Nos. 1 to 21). Note that, in the tables, the term “Not measured” means that measurement has not yet been performed.

TABLE 1

| | | Examples | | | | | | |
|---|---|---|---|---|---|---|---|---|
| | | No. 1 | No. 2 | No. 3 | No. 4 | No. 5 | No. 6 | No. 7 |
| Glass | SiO₂ | 61.1 | 60.3 | 61.6 | 61.4 | 61.1 | 57.4 | 58.7 |
| composition | Al₂O₃ | 12.9 | 13.0 | 9.8 | 11.0 | 12.3 | 13.3 | 13.1 |
| (mol %) | MgO | 6.5 | 6.6 | 6.6 | 6.6 | 6.5 | 6.7 | 6.7 |
| | CaO | — | — | — | — | — | — | — |
| | B₂O₃ | — | — | — | — | — | — | — |
| | ZrO₂ | — | — | — | — | — | 1.1 | 1.1 |
| | Li₂O | — | — | — | — | — | — | — |
| | Na₂O | 15.9 | 16.0 | 16.1 | 16.0 | 16.0 | 16.4 | 16.2 |
| | K₂O | 3.5 | 3.5 | 3.5 | 3.5 | 3.5 | 3.6 | 3.6 |
| | P₂O₅ | — | 0.5 | 2.3 | 1.4 | 0.5 | 1.4 | 0.5 |
| | SnO₂ | — | 0.1 | 0.1 | 0.1 | 0.1 | 0.1 | 0.1 |
| | SO₃ | 0.03 | — | — | — | — | — | — |
| | Cl | 0.07 | — | — | — | — | — | — |

| | | | | | | | |
|---|---|---|---|---|---|---|---|
| Mg + Ca | 6.5 | 6.6 | 6.6 | 6.6 | 6.5 | 6.7 | 6.6 |
| (Al + Na + P)/Si | 0.5 | 0.5 | 0.5 | 0.5 | 0.5 | 0.5 | 0.5 |
| (B + Na)/Si | 0.26 | 0.27 | 0.26 | 0.26 | 0.26 | 0.29 | 0.28 |
| P/Si | 0 | 0.008 | 0.038 | 0.023 | 0.008 | 0.025 | 0.008 |
| Al/Si | 0.2 | 0.2 | 0.2 | 0.2 | 0.2 | 0.2 | 0.2 |
| Na/Al | 1.2 | 1.2 | 1.6 | 1.5 | 1.3 | 1.2 | 1.2 |
| ρ (g/cm³) | 2.47 | 2.48 | 2.46 | 2.47 | 2.47 | 2.51 | 2.51 |
| α (×10⁻⁷/° C.) | 102 | 102 | 110 | 105 | 103 | 104 | 101 |
| Ps (° C.) | 585 | 584 | 553 | 553 | 575 | 600 | 602 |
| Ta (° C.) | 634 | 832 | 602 | 600 | 623 | 648 | 651 |
| Ts (° C.) | 866 | 865 | 855 | 833 | 854 | 876 | 879 |
| 10^{4.0} dPa · s (° C.) | 1,225 | 1,226 | 1,176 | 1,197 | 1,214 | 1,214 | 1,219 |
| 10^{3.0} dPa · s (° C.) | 1,412 | 1,412 | 1,369 | 1,388 | 1,400 | 1,388 | 1,395 |
| 10^{2.5} dPa · s (° C.) | 1,528 | 1,529 | 1,489 | 1,507 | 1,515 | 1,497 | 1,505 |
| TL (° C.) | 1,150 | 1,150 | 1,090 | 1,040 | 1,120 | 1,088 | 1,140 |
| log₁₀η_{TL} (dPa · s) | 4.5 | 4.3 | 4.7 | 5.2 | 4.7 | 5.0 | 4.6 |
| CS [MPa] | 1,015 | 987 | 757 | 806 | 921 | 1,080 | 1,093 |
| DOL [μm] | 65 | 69 | 82 | 77 | 71 | 69 | 64 |
| Mass reduction caused | 40.1 | 40.2 | 0.4 | 17.7 | Not | Not | Not |
| by HCl (g/cm²) | | | | | measured | measured | measured |

TABLE 2

| | | Examples | | | | | | |
|---|---|---|---|---|---|---|---|---|
| | | No. 8 | No. 9 | No. 10 | No. 11 | No. 12 | No. 13 | No. 14 |
| Glass | SiO₂ | 60.4 | 65.0 | 64.2 | 63.5 | 62.9 | 62.3 | 60.7 |
| composition | Al₂O₃ | 11.7 | 9.5 | 10.2 | 10.8 | 9.7 | 10.3 | 10.5 |
| (mol %) | MgO | 6.6 | 6.4 | 6.4 | 6.4 | 6.5 | 6.5 | 6.6 |
| | CaO | — | — | — | — | — | — | — |
| | B₂O₃ | — | — | — | — | — | — | — |
| | ZrO₂ | 1.1 | — | — | — | — | — | — |
| | Li₂O | — | — | — | — | — | — | — |
| | Na₂O | 16.1 | 15.6 | 15.7 | 15.7 | 15.9 | 15.9 | 16.2 |
| | K₂O | 3.5 | 3.4 | 3.4 | 3.5 | 3.5 | 3.5 | 3.5 |
| | P₂O₅ | 0.5 | — | — | — | 1.4 | 1.4 | 2.4 |
| | SnO₂ | 0.1 | — | — | — | 0.1 | 0.1 | 0.1 |
| | SO₃ | — | 0.07 | 0.01 | — | — | — | — |
| | Cl | — | 0.03 | 0.09 | 0.10 | — | — | — |

| | | | | | | | |
|---|---|---|---|---|---|---|---|
| Mg + Ca | 6.6 | 6.4 | 6.4 | 6.4 | 6.5 | 6.5 | 6.6 |
| (Al + Na + P)/Si | 0.5 | 0.4 | 0.4 | 0.4 | 0.4 | 0.4 | 0.5 |
| (B + Na)/Si | 0.27 | 0.24 | 0.24 | 0.25 | 0.25 | 0.26 | 0.27 |
| P/Si | 0.008 | 0 | 0 | 0 | 0.022 | 0.022 | 0.039 |
| Al/Si | 0.2 | 0.1 | 0.2 | 0.2 | 0.2 | 0.2 | 0.2 |
| Na/Al | 1.4 | 1.6 | 1.5 | 1.5 | 1.6 | 1.5 | 1.5 |
| ρ (g/cm³) | 2.50 | 2.46 | 2.46 | 2.46 | 2.46 | 2.46 | 2.46 |
| α (×10⁻⁷/° C.) | 101 | 101 | 102 | 102 | 103 | 103 | 110 |
| Ps (° C.) | 586 | 540 | 548 | 558 | 541 | 549 | 564 |
| Ta (° C.) | 634 | 585 | 595 | 606 | 587 | 596 | 614 |
| Ts (° C.) | 862 | 811 | 822 | 834 | 824 | 832 | 868 |
| 10^{4.0} dPa · s (° C.) | 1,208 | 1,182 | 1,192 | 1,203 | 1,182 | 1,189 | 1,189 |
| 10^{3.0} dPa · s (° C.) | 1,387 | 1,380 | 1,387 | 1,398 | 1,376 | 1,381 | 1,379 |
| 10^{2.5} dPa · s (° C.) | 1,500 | 1,505 | 1,510 | 1,522 | 1,499 | 1,504 | 1,498 |
| TL (° C.) | 1,080 | Not | 980 | 1,000 | 1,110 | 1,050 | Not |
| | | measured | | | | | measured |
| log₁₀η_{TL} (dPa · s) | 5.0 | Not | 5.7 | 5.6 | 4.5 | 5.0 | Not |
| | | measured | | | | | measured |
| CS [MPa] | 1,011 | 865 | 742 | 754 | 853 | 810 | 835 |
| DOL [μm] | 65 | 68 | 75 | 65 | 64 | 73 | 81 |
| Mass reduction caused | Not | Not | 0.52 | 0.12 | 0.45 | 1.02 | 0.55 |
| by HCl (g/cm²) | measured | measured | | | | | |

TABLE 3

| | | Examples | | | | | | |
|---|---|---|---|---|---|---|---|---|
| | | No. 15 | No. 16 | No. 17 | No. 18 | No. 19 | No. 20 | No. 21 |
| Glass | SiO₂ | 59.8 | 61.4 | 62.6 | 61.1 | 65.8 | 62.1 | 63.9 |
| composition | Al₂O₃ | 11.2 | 9.8 | 11.5 | 11.6 | 10.6 | 11.4 | 8.4 |
| (mol %) | MgO | 6.7 | 6.6 | 6.5 | 6.6 | 4.7 | 6.6 | 3.3 |
| | CaO | — | — | — | — | — | — | 2.4 |
| | B₂O₃ | — | — | — | — | 0.6 | — | — |
| | ZrO₂ | — | 1.1 | — | 1.1 | — | — | 2.4 |
| | Li₂O | — | — | — | — | — | — | 0.2 |
| | Na₂O | 16.2 | 16.1 | 15.8 | 16.0 | 13.3 | 15.0 | 15.4 |
| | K₂O | 3.6 | 3.5 | 3.5 | 3.5 | 2.7 | 3.5 | 3.9 |
| | P₂O₅ | 2.4 | 1.4 | — | — | 2.2 | 1.4 | — |
| | SnO₂ | 0.1 | 0.1 | — | — | 0.1 | — | — |
| | SO₃ | — | — | 0.05 | 0.08 | — | — | 0.08 |
| | Cl | — | — | 0.05 | 0.02 | — | — | — |

| | | | | | | | |
|---|---|---|---|---|---|---|---|
| Mg + Ca | 6.7 | 6.6 | 6.5 | 6.5 | 4.7 | 6.6 | 5.6 |
| (Al + Na + P)/Si | 0.5 | 0.4 | 0.4 | 0.5 | 0.4 | 0.4 | 0.37 |
| (B + Na)/Si | 0.27 | 0.26 | 0.25 | 0.26 | 0.21 | 0.24 | 0.24 |
| P/Si | 0.039 | 0.023 | 0 | 0 | 0.034 | 0.023 | 0.001 |
| Al/Si | 0.2 | 0.2 | 0.2 | 0.2 | 0.2 | 0.2 | 0.13 |
| Na/Al | 1.5 | 1.6 | 1.4 | 1.4 | 1.3 | 1.3 | 1.83 |
| ρ (g/cm³) | 2.46 | 2.49 | 2.47 | 2.50 | 2.42 | 2.46 | 2.54 |
| α (×10⁻⁷/° C.) | 109 | 102 | 102 | 103 | 93 | 102 | 102 |
| Ps (° C.) | 574 | 562 | 567 | 586 | 585 | 570 | 533 |
| Ta (° C.) | 624 | 610 | 614 | 635 | 639 | 619 | 576 |
| Ts (° C.) | Not | 844 | 844 | 862 | 932 | 867 | 793 |
| | measured | | | | | | |
| 10^{4.0} dPa · s (° C.) | 1,193 | 1,183 | 1,208 | 1,209 | 1,280 | 1,227 | 1,142 |
| 10^{3.0} dPa · s (° C.) | 1,382 | 1,366 | 1,398 | 1,390 | 1,484 | 1,421 | 1,319 |
| 10^{2.5} dPa · s (° C.) | 1,500 | 1,482 | 1,517 | 1,505 | 1,612 | 1,542 | 1,431 |
| TL (° C.) | Not | Not | Not | Not | Not | Not | 880 |
| | measured | measured | measured | measured | measured | measured | |
| log₁₀η_{TL} (dPa · s) | Not | Not | Not | Not | Not | Not | 6.4 |
| | measured | measured | measured | measured | measured | measured | |
| CS [MPa] | 838 | 833 | 903 | 1,047 | 768 | 861 | 886 |
| DOL [μm] | 86 | 71 | 67 | 59 | 80 | 75 | 44 |
| Mass reduction | Not | Not | Not | Not | Not | Not | 0.3 |
| caused by HCl (g/cm²) | measured | measured | measured | measured | measured | measured | |

Each of the samples in the tables was produced as described below. First, glass raw materials were blended so as to have glass compositions shown in the tables, and melted at 1,580° C. for 8 hours using a platinum pot. Thereafter, the resultant molten glass was cast on a carbon plate and formed into a sheet shape. The resultant glass sheet was evaluated for its various properties.

The density ρ is a value obtained through measurement by a well-known Archimedes method.

The thermal expansion coefficient α is a value obtained through measurement of an average thermal expansion coefficient in the temperature range of 30 to 380° C. using a dilatometer.

The strain point Ps and the annealing point Ta are values obtained through measurement based on a method of ASTM C336.

The softening point Ts is a value obtained through measurement based on a method of ASTM C338.

The temperatures at the high temperature viscosities of 10^{4.0} dPa·s, 10^{3.0} dPa·s, and 10^{2.5} dPa·s are values obtained through measurement by a platinum sphere pull up method.

The liquidus temperature TL is a value obtained through measurement of a temperature at which crystals of glass are deposited after glass powder that passes through a standard 30-mesh sieve (sieve opening: 500 μm) and remains on a 50-mesh sieve (sieve opening: 300 μm) is placed in a platinum boat and then kept for 24 hours in a gradient heating furnace.

The liquidus viscosity log₁₀ η_{TL} is a value obtained through measurement of a viscosity of glass at the liquidus temperature by a platinum sphere pull up method.

The mass reduction of glass caused by an HCl aqueous solution was evaluated as follows. First, each of the samples was processed into a strip shape measuring 20 mm by 50 mm by 1 mm and its surfaces were then sufficiently washed with isopropyl alcohol. Next, each of the samples was dried and its mass was measured. Further, 100 ml of a 10-mass % HCl aqueous solution were prepared and were poured into a Teflon (trademark) bottle, and then the temperature was set to 80° C. Subsequently, each of the samples was immersed in the 10-mass % HCl aqueous solution for 24 hours, thereby etching the entire surface (including edge surfaces) of each of the samples. Finally, the mass of each of the etched samples was measured, and then the mass reduction of each of the samples was divided by the surface area thereof, thereby calculating the mass reduction per unit area.

As evident from Tables 1 to 3, each of Samples Nos. 1 to 21 having a density of 2.54 g/cm³ or less and a thermal expansion coefficient of 93 to 110×10⁻⁷/° C. was found to be suitable as a material for a tempered glass, i.e., a glass to be tempered. Further, each of the samples has a liquidus viscosity of 10^{4.3} dPa·s or more, and hence can be formed into a sheet shape. Further, each of the samples has a temperature at 10^{4.0} dPa·s of 1,280° C. or less, and hence does not impose a large burden on forming equipment. Moreover, each of the samples has a temperature at 10^{2.5} dPa·s of 1,612° C. or less, and hence is expected to allow a large number of glass sheets to be produced at low cost with high productivity. Note that the glass compositions of a surface layer of glass before and after tempering treatment are different from each other microscopically, but the glass composition of the whole glass is not substantially changed before and after the tempering treatment.

Subsequently, both surfaces of each of the samples were subjected to optical polishing, and then subjected to ion exchange treatment including immersion in a KNO₃ molten salt at 440° C. for 6 hours. After completion of the ion exchange treatment, the surface of each of the samples was washed. Then, the stress compression value CS and thickness DOL of a compression stress layer in the surface were calculated from the number of interference stripes and each interval between the interference fringes, the interference fringes being observed with a surface stress meter (FSM-6000 manufactured by Toshiba Corporation). In the calculation, the refractive index and optical elastic constant of each of the samples were set to 1.52 and 28 [(nm/cm)/MPa], respectively.

As evident from Tables 1 to 3, when each of Samples Nos. 1 to 21 was subjected to ion exchange treatment in a KNO₃ molten salt, CS was found to be 741 MPa or more, and DOL was found to be 44 μm or more.

### Example 2

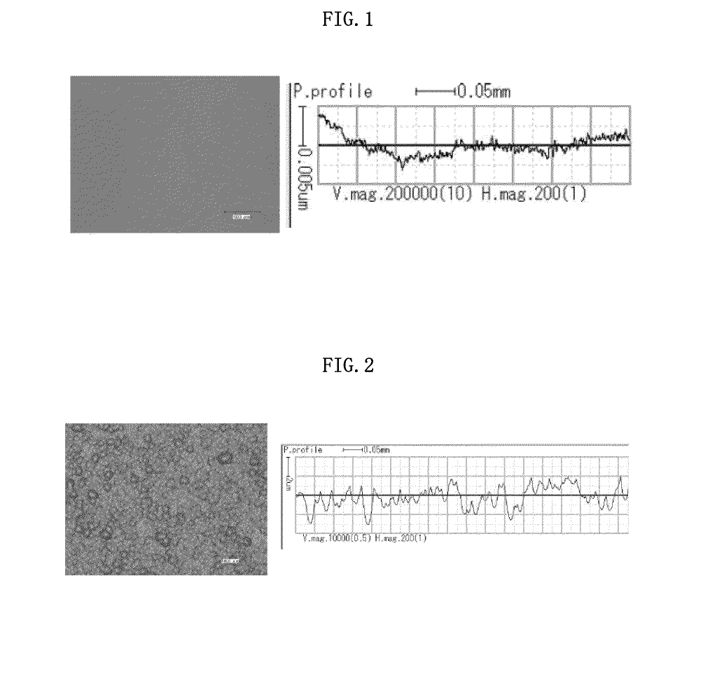

The glass of Sample No. 21 was formed into a glass sheet having a thickness of 1.0 mm by a float method. Note that the surface roughness Ra of the front surface of the glass sheet was 0.0002 μm and the Ra of the back surface of the glass sheet was 0.009 μm. Next, both the surfaces (excluding the edge surfaces) of the glass sheet were each polished so that the surfaces have a mirror surface. The polished surfaces had a surface roughness Ra of 0.0002 μm. The polished glass sheet was cut into a glass sheet having a size of 50 mm by 100 mm and the edge surfaces thereof were lapped with Al₂O₃ with a particle size of Number 600. The lapped glass sheet was immersed in a 5-mass % HF aqueous solution at 25° C. for 10 minutes, and then the surface roughness Ra of the surfaces (excluding the edge surfaces) and the surface roughness Ra of the edge surfaces were measured. For reference, FIG. 1 shows an observation image and roughness profile of a surface of the lapped glass sheet after being immersed in the 5-mass % HF aqueous solution at 25° C. for 10 minutes, and FIG. 2 shows an observation image and roughness profile of an edge surface of the lapped glass sheet. Here, the term “surface roughness Ra” refers to a value obtained by a measurement method in accordance with SEMI D7-94 “FPD glass substrate surface roughness measurement method.”

As the results of the measurement, it was found that the surface roughness Ra of both the surfaces was 0.0003 μm, the surface roughness Ra of the edge surfaces was 0.77 μm, and the value of (surface roughness Ra of edge surfaces)/(surface roughness Ra of surfaces) was 2,566.

### INDUSTRIAL APPLICABILITY

The tempered glass and tempered glass sheet of the present invention are suitable for a cover glass of a cellular phone, a digital camera, a PDA, or the like, or a glass substrate for a touch panel display or the like. Further, the tempered glass and tempered glass sheet of the present invention can be expected to find use in applications requiring high mechanical strength, for example, a window glass, a substrate for a magnetic disk, a substrate for a flat panel display, a cover glass for a solar cell, a cover glass for a solid image pick-up element, and tableware, in addition to the above-mentioned applications.

1. A tempered glass having a compression stress layer in a surface thereof, the tempered glass comprising, as a glass composition in terms of mol %, 45 to 75% of SiO₂, 3 to 15% of Al₂O₃, 0 to 12% of Li₂O, 0.3 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein the surface is etched partially or entirely before tempering treatment.

2. The tempered glass according to claim 1, wherein the tempered glass comprises, as a glass composition in terms of mol %, 45 to 75% of SiO₂, 4 to 13% of Al₂O₃, 0 to 3% of B₂O₃, 0 to 8% of Li₂O, 5 to 20% of Na₂O, 0.1 to 10% of K₂O, and 3 to 13% of MgO+CaO, and has a molar ratio (Al₂O₃+Na₂O+P₂O₅)/SiO₂ of 0.1 to 0.7, a molar ratio (B₂O₃+Na₂O)/SiO₂ of 0.1 to 0.7, a molar ratio P₂O₅/SiO₂ of 0 to 0.5, a molar ratio Al₂O₃/SiO₂ of 0.01 to 0.7, and a molar ratio Na₂O/Al₂O₃ of 0.5 to 4.

3. The tempered glass according to claim 1, wherein the tempered glass comprises, as a glass composition in terms of mol %, 45 to 75% of SiO₂, 5 to 12% of Al₂O₃, 0 to 1% of B₂O₃, 0 to 4% of Li₂O, 8 to 20% of Na₂O, 0.5 to 10% of K₂O, and 5 to 13% of MgO+CaO, and has a molar ratio (Al₂O₃+Na₂O+P₂O₅)/SiO₂ of 0.1 to 0.5, a molar ratio (B₂O₃+Na₂O)/SiO₂ of 0.1 to 0.5, a molar ratio P₂O₅/SiO₂ of 0 to 0.3, a molar ratio Al₂O₃/SiO₂ of 0.05 to 0.5, and a molar ratio Na₂O/Al₂O₃ of 1 to 3.

4. The tempered glass according to claim 1, wherein the tempered glass comprises, as a glass composition in terms of mol %, 45 to 75% of SiO₂, 5 to 11% of Al₂O₃, 0 to 1% of B₂O₃, 0 to 4% of Li₂O, 9 to 20% of Na₂O, 0.5 to 8% of K₂O, 0 to 12% of MgO, 0 to 3% of CaO, and 5 to 12% of MgO+CaO, and has a molar ratio (Al₂O₃+Na₂O+P₂O₅)/SiO₂ of 0.1 to 0.5, a molar ratio (B₂O₃+Na₂O)/SiO₂ of 0.1 to 0.3, a molar ratio P₂O₅/SiO₂ of 0 to 0.2, a molar ratio Al₂O₃/SiO₂ of 0.05 to 0.3, and a molar ratio Na₂O/Al₂O₃ of 1 to 3.

5. The tempered glass according to claim 1, wherein the tempered glass comprises, as a glass composition in terms of mol %, 50 to 70% of SiO₂, 5 to 11% of Al₂O₃, 0 to 1% of B₂O₃, 0 to 2% of Li₂O, 10 to 18% of Na₂₀, 1 to 6% of K₂O, 0 to 12% of MgO, 0 to 2.5% of CaO, and 5 to 12% of MgO+CaO, and has a molar ratio (Al₂O₃+Na₂O+P₂O₅)/SiO₂ of 0.2 to 0.5, a molar ratio (B₂O₃+Na₂O)/SiO₂ of 0.15 to 0.27, a molar ratio P₂O₅/SiO₂ of 0 to 0.1, a molar ratio Al₂O₃/SiO₂ of 0.07 to 0.2, and a molar ratio Na₂O/Al₂O₃ of 1 to 2.3.

6. The tempered glass according to claim 1, wherein the surface is etched partially or entirely with an etching liquid comprising at least one kind selected from the group consisting of HF, HCl, H₂SO₄, HNO₃, NH₄F, NaOH, and NH₄HF₂.

7. The tempered glass according to claim 1, wherein a surface roughness Ra of the etched surface is 1 nm or less.

8. The tempered glass according to claim 1, wherein the tempered glass has a value of (surface roughness Ra of edge surface)/(surface roughness Ra of etched surface) of 1 to 5,000.

9. The tempered glass according to claim 1, wherein a compression stress value of the compression stress layer is 200 MPa or more, and a thickness of the compression stress layer is 10 μm or more.

10. The tempered glass according to claim 1, wherein the tempered glass has a liquidus temperature of 1,250° C. or less.

11. The tempered glass according to claim 1, wherein the tempered glass has a liquidus viscosity of 10^{4.0} dPa·s or more.

12. The tempered glass according to claim 1, wherein the tempered glass has a temperature at 10^{4.0} dPa·s of 1,280° C. or less.

13. The tempered glass according to claim 1, wherein the tempered glass has a temperature at 10^{2.5} dPa·s of 1,620° C. or less.

14. The tempered glass according to claim 1, wherein the tempered glass has a density of 2.6 g/cm³ or less.

15. A tempered glass sheet, comprising the tempered glass according to claim 1.

16. The tempered glass sheet according to claim 15, wherein the tempered glass sheet is formed by a float method.

17. The tempered glass sheet according to claim 15, wherein the tempered glass sheet is used for a touch panel display.

18. The tempered glass sheet according to claim 15, wherein the tempered glass sheet is used for a cover glass for a cellular phone.

19. The tempered glass sheet according to claim 15, wherein the tempered glass sheet is used for a cover glass for a solar cell.

20. The tempered glass sheet according to claim 15, wherein the tempered glass sheet is used for a protective member for a display.

21. A glass to be tempered, comprising, as a glass composition in terms of mol %, 45 to 75% of SiO₂, 3 to 15% of Al₂O₃, 0 to 12% of Li₂O, 0 to 20% of Na₂O, 0 to 10% of K₂O, and 1 to 15% of MgO+CaO, and having a molar ratio (Al₂O₃+Na₂O+P₂O₅)/SiO₂ of 0.1 to 1, a molar ratio (B₂O₃+Na₂O)/SiO₂ of 0.1 to 1, a molar ratio P₂O₅/SiO₂ of 0 to 1, a molar ratio Al₂O₃/SiO₂ of 0.01 to 1, and a molar ratio Na₂O/Al₂O₃ of 0.1 to 5, wherein a surface of the glass to be tempered is etched partially or entirely.

22. The glass to be tempered according to claim 21, wherein the glass to be tempered has a mass reduction of 0.05 to 50 g/cm² when immersed in a 10-mass % HCl aqueous solution at 80° C. for 24 hours.
